(19) United States
(12) Patent Application Publication
(10) Pub. No.: US 2010/0325842 A1
(43) Pub. Date: Dec. 30, 2010

(54) Apparatus to secure towels and the like

(76) Inventor: Cynthia Lynn Rivera, Clarksville, MD (US)

Correspondence Address: Cynthia Rivera, PO Box 32, Columbia, MD, 21045, US

(21) Appl. No.: 12/494,577

(22) Filed: Jun. 30, 2009

(51) Int. Cl. A44B 99/00; G09F 3/00

(52) U.S. Cl. 24/3.4; 40/316

(57) ABSTRACT

An apparatus to secure towels and the like with a flexible strap or cord of a length sized to go at least partially around the neck of the wearer, with left and right fasteners secured to the strap at its terminals for fastening a towel or other drape in use position, the strap or cord is adjustable by a mechanism that adjusts the length of the strap to the preference of the wearer, preferably, the fasteners are oriented such that, when the holder is in use the fixed portion of the clip, which is attached to the strap, lies facing away from the wearers body so that any decorative material present is visible to an observer, and attached to both fasteners on the side facing the wearer is a magnet to support the apparatus when attached to a magnetic surface,

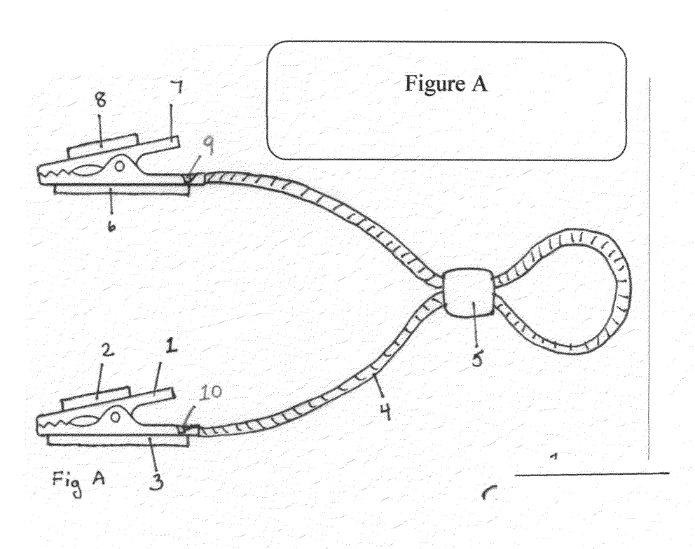

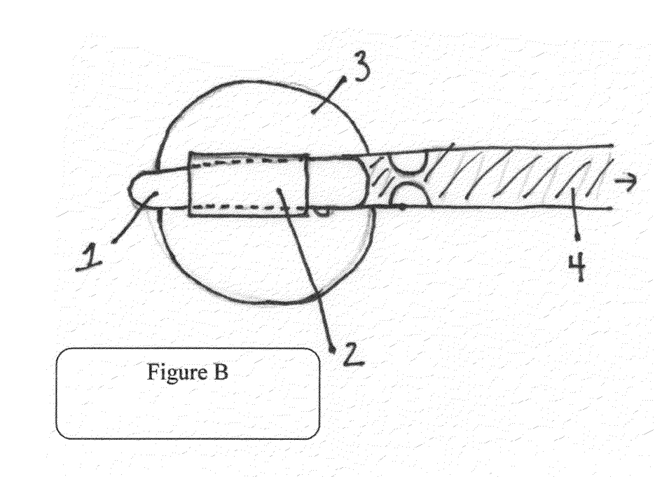

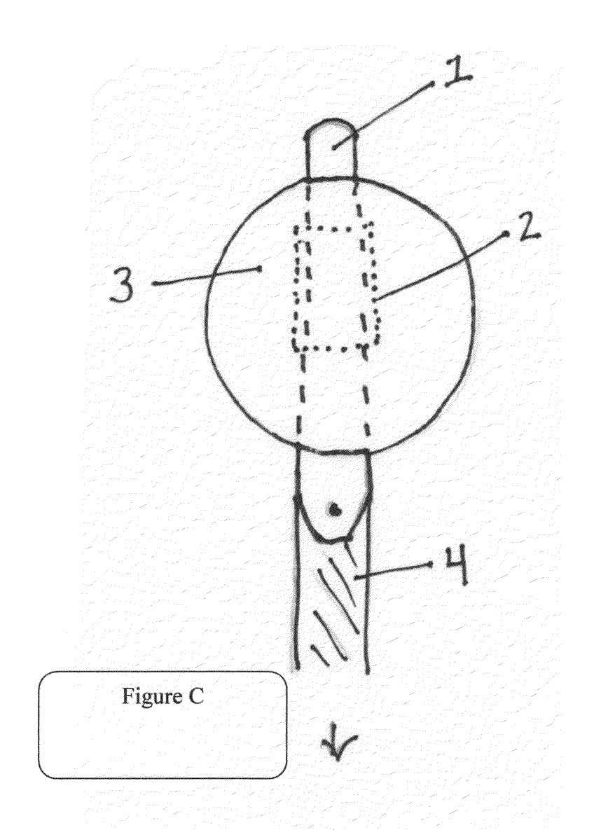

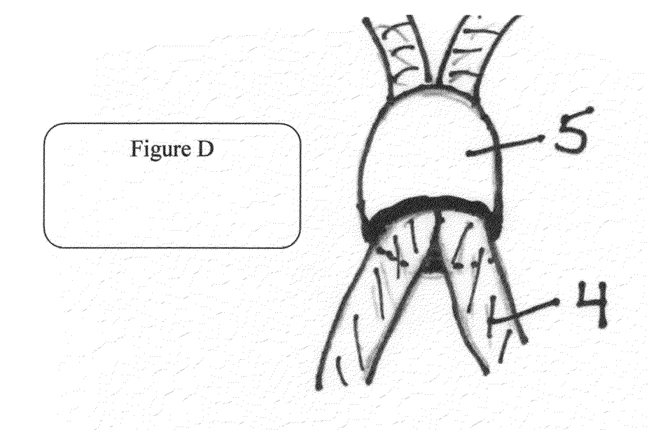

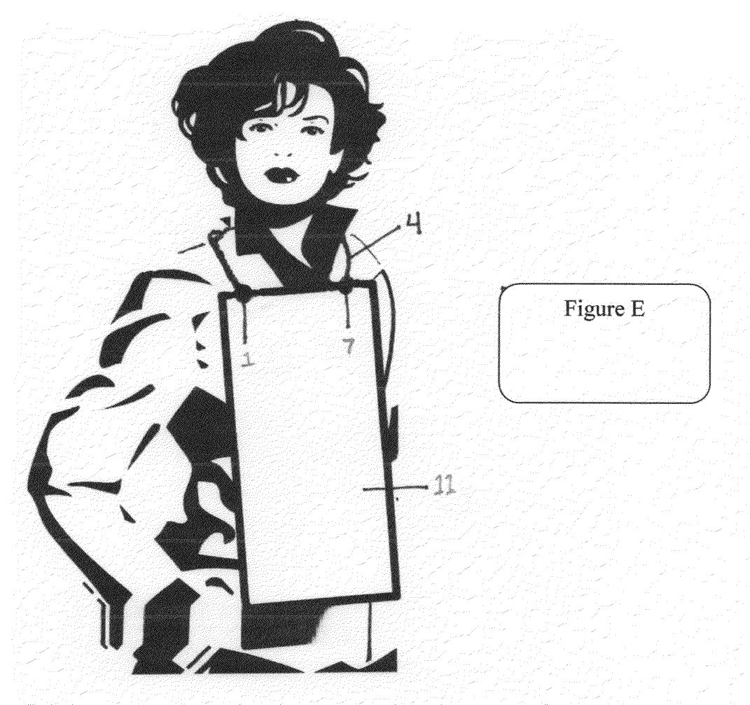

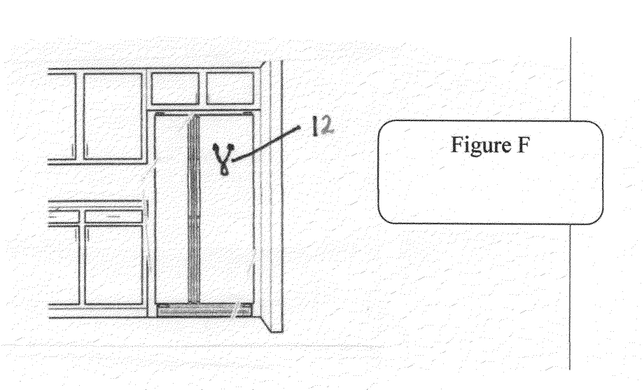

### CROSS REFERENCE TO RELATED APPLICATIONS

This application is based on provisional application, Ser. No. 61/076,709, filed on Jun. 30, 2008.

### STATEMENT REGARDING FEDERALLY SPONSORED RESEARCH OR DEVELOPMENT Not Applicable

Description of Attached Appendix

Not Applicable

### BACKGROUND OF THE INVENTION

This invention relates generally to the field of non-electric cooking tools and kitchen gadgets and more specifically to an apparatus to secure towels and the like. The only choice today's cook has to protect their clothing from kitchen splatters is what style of apron they are willing to use, if any. A cook's clothes are subjected to kitchen splatters, splashes, and messes caused by preparing, cooking, grilling, serving, and cleaning up in the kitchen. The use of this apparatus and a user supplied kitchen towel protect the core area dirtied by kitchen splatters: from the chest to below the waist. And since the apparatus can be stored on a magnetic surface and utilize the usually plentiful kitchen towel to complete the application, this device is convenient, efficient, and economical. This apparatus was invented from necessity. After ruining many shirts from kitchen tasks performed once home from work, a device was needed to protect clothing from kitchen splatters.

After researching solutions to the problem stated previously, there were alternate approaches to the problem. The first is the traditional apron. This protects the wearer's clothing during kitchen tasks. Additional research also located the following patents:
20040093702,. Single piece clothing protective device,
2005027398, Securement devices for bibs and the like
U.S. Pat. No. 6,836,899, Device for detachable holding and absorbent napkin across the torso
5,852,849, Bib holder for holding dental bibs.

The traditional apron has several problems: 1) It creates additional laundry to wash and iron, 2) It is bulky to hang and store the number of clean aprons that are needed between laundry loads, 3) It is time consuming to locate in the laundry or linen cabinets, 4) It has a negative stereotype as “old-fashioned”, and 5) Traditional aprons themselves can be expensive. This device solves these issues because by using this apparatus with your kitchen towel shirt fronts are protected from kitchen splatters saving your shirts from being dirtied, stained and ruined, and 1) No additional laundry is generated since you use a readily available and usually plentiful kitchen towel to attach to the device, 2) they are efficient so one per cook is all that is needed, 3) they are small and magnetic so they store on a magnetic surface so they are where you need them, when you need them, 4) With different decorative designs on the device along with the purchasers own towels they appeal to today's cooks, and 5) the apparatus is an economical choice when compared to the cost of all the traditional aprons needed for the same benefit received from one set of apparatus.

The issues with #20040093702, Single piece clothing protective device relate to the amount of coverage the wearer receives from a single device and the impact the weight of the drape would have on the wearer's apparel. With #2005027398, Securement devices for bibs and the like the device does not contain a magnet for easy storage; additionally the structure of the clip and cord adjustment mechanism differs from those of this application. U.S. Pat. No. 6,836,899, Device for detachable holding and absorbent napkin across the torso differs from this application in that it utilizes magnets to attach the drape in front of the wearer and this was found to be insufficient to support the towel and the like in the use described. Finally, U.S. Pat. No. 5,852,849, Bib holder for holding dental bibs functioned similarly, but did not contain the magnet for storage and the decorative material option.

### BRIEF SUMMARY OF THE INVENTION

The primary object of the invention is to provide a device to secure towels or other drape to protect clothing during kitchen tasks or other tasks.

Another object of the invention is to provide an apparatus that is comfortable to wear, that is quickly available, and that is easily used.

Yet another object of the invention is to provide an apparatus that is easily fastened to a towel, is readily introduced around the neck of the user and does not generate additional laundry to wash

Another object of the invention is to provide an apparatus that is magnetic so that it that stores easily, quickly, and is not bulky to store

Still another object of the invention is to provide an apparatus that is decorative.

Other objects and advantages of the present invention will become apparent from the following descriptions, taken in connection with the accompanying drawings, wherein, by way of illustration and example, an embodiment of the present invention is disclosed.

This is an apparatus to secure towels and the like to protect clothing during kitchen and other tasks. This device comprises of: a flexible strap or cord of a length sized to go at least partially around the neck of the wearer, with left and right fasteners secured to the strap at its terminals for fastening a towel or other drape in use position, the strap or cord is adjustable by a mechanism that adjusts the length of the strap to the preference of the wearer, preferably, the fasteners are oriented such that, when the holder is in use the fixed portion of the clip, which is attached to the strap, lies facing away from the wearer's body so that any decorative material present is visible to an observer, the fiat surface of the central expanded portion lies against the wearer's chest, attached to the both fasteners on the side facing outward from the wearer are decorative materials, and attached to both fasteners on the side facing the wearer is a magnet used to support the apparatus for storage when attached to a magnetic surface.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The apparatus to secure a towel and the like is a device for holding a towel, napkin, drape, and the like in position over the wearer to protect the clothing while performing kitchen tasks and other tasks. To operate this device the at home chef simply clips the fasteners at each end of the strap/cord to the narrow ends of a user supplied kitchen towel and the like. The strap/cord is then placed over one's head and around one's neck with the towel covering the chest. The fit mechanism is then adjusted for position and comfort. The at home chef is that, easily able protect their clothing: during cooking or other tasks. Then when the tasks are completed, the clips are released from the towel, the device is removed from the user, and is stored conveniently on a magnetic surface such as a refrigerator until needed again.

With reference to the drawings, in FIG E. a user is shown wearing an apparatus attached to a kitchen towel across the chest, secured in place by device in accordance with the invention. The apparatus has a flexible strap 4 having an adjustment mechanism for wearer-determined comfort 5, and two terminal ends 10 and 9. The total length of the flexible strap 4 is selected to be sufficient at least to go around the nape and preferably all the way around the neck of a user. Fasteners 1 and 7 are secured to each terminal end 10 and 9. The fasteners 1 and 7 may be attached at the terminals 10 and 9 in a fixed position as described further below, or, if desired, they may be rotably secured at the terminals 10 and 9 for increased flexibility and comfort during use. In operation this apparatus is used by attaching the fasteners 1 and 7 to a towel 10, preferably a kitchen towel, placing the strap 4 over one's head and around one's neck with the towel covering the chest, and adjusting mechanism 5 for position and comfort, as seen in FIG. E, to protect one's clothing during cooking or other tasks. When task is completed, the fasteners 1 and 7 are released from the towel, the apparatus is removed from the user, and may be placed on a surface such as a refrigerator as in FIG. F using the magnets 2 and 8 to store until further needed.

Additionally, as shown in FIG. C, attached to fasteners 1 and 7 are 3 and 6 decorative materials which may contain printed material or other images or designs imprinted or otherwise affixed to the surface, or molded as an integral part of the surface, all referred to generally herein as decorative material. Preferably, the decorative material is visible when the strap is in use. Such decorative material may comprise, for example, buttons, wooden cutouts, resin shapes, ceramic objects, natural elements, or other like items. Alternatively, such decorative material may comprise humorous or comforting designs, such as inspirational quotations or cartoon characters or soothing scenes, logos, trademarks, trade names, advertising slogans or the like. Such decorative material may further or in addition comprise bold or bright or “designer” colors, or other material, which attracts or is designed to attract the attention of either the wearer or the viewer or both. Such decorative material may comprise sparkling or glittering substances, or fluorescent material. The strap itself may comprise single-colored or multi-colored material, and may in addition comprise attention-attracting material such as sparkling or glittering substances, or fluorescent material.

The strap 4 is preferably formed of a material that is flexible, soft, resilient and lightweight. The strap is adjustable by mechanism 5 that adjusts the length of the strap to the preference of the wearer. As shown in FIG. D, the preferred design the strap terminals 10 and 9 are inserted into one end of the mechanism 5 and pulled until the mechanism 5 is halfway down the strap 4 to the loop formed when the strap 4 is doubled.

The terminals 10 and 9 may be flattened, or they may be any shape necessary to accommodate the fasteners 1 and 7 as illustrated in FIGS. A, B and C.

The fasteners 1 and 7 may be any desired fastening means, including but not limited to alligator clips, spring clips, clamps, or any other fastening means that will allow a kitchen towel or other drape to be releasably attached to the device. Preferably, such fasteners are clips having spring-loaded jaws as best illustrated in FIG. A.

The fasteners 1 and 7 may be affixed to the strap terminals 10 and 9 by any means, including rivets, pins, adhesives, and crimping, or they may be integrally formed during the molding process. Such attachment means may be fixed or rotatable.

Attached to fasteners 1 and 7, on the flat surface of the central expanded portion, are magnets 2 and 8 in any shape necessary to support apparatus when attached to a magnetic surface 12 similar to FIG. F. As shown in FIG B, the magnet shape is preferably a rectangle not much wider than the fastener 1 and 7 and half as long as the fasteners 1 and 7. Attached means affixed by any means including adhesives, pins, crimping, or integrally attached or formed during molding process.

Though described in detail herein with respect to an apron, it should be noted that the present invention is not limited in application to aprons only. The device may be used with other types of towels, including dishtowels, handkerchiefs, dinner napkins, or other drapes, such as are used or available when cooking or working in the kitchen or elsewhere, or when additional protection is needed.

It is understood that this invention is not confined to the particular structures herein illustrated and described, but embraces such modified forms thereof as come within the scope of the claims.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. A is a side view of the invention

FIG. B is bottom view of the apparatus illustrating a preferred structure by which a fastener may be attached to the strap and the magnet attached to the fastener.

FIG. C is a top view of the invention.

FIG. D is a view of the inventions preferred strap length adjusting method.

FIG. E is an illustrative view of apparatus in accordance with the present invention in use position on a user.

FIG F. is a pictorial view of the device in storage position on a refrigerator.

What is claimed is:

1. An apparatus to secure towels and the like comprising:
a flexible strap or cord of a length sized to go at least partially around the neck of the wearer;
with left and right fasteners secured to the strap at its terminals for fastening a towel or other drape in use position;
the strap or cord is adjustable by a mechanism that adjusts the length of the strap to the preference of the wearer;
preferably, the fasteners are oriented such that, when the holder is in use the fixed portion of the clip, which is attached to the strap, lies facing away from the wearer's body so that any decorative material present is visible to an observer;
the flat surface of the central expanded portion lies against the wearer's chest;
attached to the both fasteners on the side facing outward from the wearer are decorative materials; and
attached to both fasteners on the side facing the wearer is a magnet to support the apparatus when attached to a magnetic surface.

2. An apparatus to secure towels and the like as claimed in claim 1 wherein said strap is preferably lightweight, relatively soft and flexible

3. An apparatus to secure towels and the like as claimed in claim 2 wherein said strap or cord material may be single colored or multi-colored

4. An apparatus to secure towels and the like as claimed in claim 3 wherein said strap material may in addition comprise of attention-attracting material such as but not limited to sparkling, glittering, or fluorescent material

5. An apparatus to secure towels and the like as claimed in claim 4 wherein said strap is adjustable by a mechanism that preferably but is not limited to, having both terminal ends of the strap inserted into one end of the mechanism and are pulled through until once the strap adjustment mechanism is halfway down the strap a loop is formed where the strap has been doubled

6. An apparatus to secure towels and the like as claimed in claim 5 wherein said decorative material for the fasteners may contain printed material or other images or designs imprinted or otherwise affixed to the surface or molded as an integral part of the surface, all referred to generally herein as decorative material

7. An apparatus to secure towels and the like as claimed in claim 6 wherein said decorative material is visible when the strap is in use

8. An apparatus to secure towels and the like as claimed in claim 7 wherein said decorative material may comprise but is not limited to buttons, wooden cutouts, resin shapes, ceramic objects, natural elements, and other like items

9. An apparatus to secure towels and the like as claimed in claim 8 wherein said decorative material may comprise of humorous or comforting designs, inspirational quotations, cartoon characters, soothing scenes, logos, trademarks, trade names, advertising slogans and the like.

10. An apparatus to secure towels and the like as claimed in claim 9 wherein said decorative material may further or in addition comprise bold or bright or “designer” colors, or other material, which attracts or is designed to attract the attention of either the wearer or the viewer or both.

11. An apparatus to secure towels and the like as claimed in claim 9 wherein said decorative material may in addition comprise of attention-attracting material such as but not limited to sparkling, glittering, or fluorescent material

12. An apparatus to secure towels and the like as claimed in claim 11 wherein said fasteners may comprise of spring-loaded jaw-type clips secured to the terminals of the strap in a fixed position in alignment with the length of the strap

13. An apparatus to secure towels and the like as claimed in claim 12 wherein said desired fastener at the strap terminals may include, but are not limited to alligator clips, spring clips, clamps, or any other fastening means that will allow a kitchen towel or other drape to be releasably attached to the device

14. An apparatus to secure towels and the like as claimed in claim 13 wherein said fasteners may be affixed to the strap terminals by any means, including rivets, pins, adhesives, crimping, or them may be integrally formed during the molding process

15. An apparatus to secure towels and the like as claimed in claim 14 wherein said fasteners may be fixed or rotatable

16. An apparatus to secure towels and the like as claimed in claim 15 wherein said magnets are attached to the fasteners, on the flat surface of the central expanded portion, in a shape and size necessary to at minimum support the apparatus when attached to a magnetic surface

17. An apparatus to secure towels and the like as claimed in claim 16 wherein said magnet is preferably a rectangle not much wider than the fastener and half as long as the fasteners

18. An apparatus to secure towels and the like as claimed in claim 17 wherein said magnet is attached to the fastener by any means including adhesives, pins, crimping, integrally attached or formed during the molding process.
